(19) United States
(12) Patent Application Publication
(10) Pub. No.: US 2012/0014799 A1
(43) Pub. Date: Jan. 19, 2012

(54) VERTICAL AXIS WIND TURBINES

(75) Inventor: Anthony James Mewburn-Crook, Egham (GB)

(73) Assignee: MATILDA'S PLANET MANUFACTURING LIMITED, Margam (UK)

(21) Appl. No.: 13/259,143

(22) PCT Filed: Mar. 24, 2010
(86) PCT No.: PCT/GB2010/050491

§ 371 Date: Sep. 22, 2011

(30) Foreign Application Priority Data
Mar. 25, 2009 (GB) 0905101.2

(51) Int. Cl. F03D 3/04

(52) U.S. Cl. 416/178

(57) ABSTRACT

A wind turbine comprising an axis intended for vertical mounting, blades arranged around the axis, and mounting arms. Each blade comprises a substantially symmetric aerofoil and is of substantially straight section lengthwise. The mounting arms are coupled to the axis and extend substantially perpendicular to the axis. Each mounting arm comprises a fairing of aerofoil shape. Each blade is mounted to the axis at both ends on respective mounting arms. The mounting arms of each blade are angularly spaced around the axis such that each blade is arranged rotated at an angle to the vertical in use and one arm leads the other when the turbine is rotating.

The present invention relates to vertical axis wind turbines, wind turbine systems, and a building comprising a wind turbine.

In contrast to horizontal axis wind turbines, where the main rotor shaft is mounted horizontally and where a mechanism must be provided to ensure that the turbine is pointing into the wind at all times for full effectiveness, a vertical axis wind turbine has the main rotor shaft mounted vertically. This arrangement has the advantage that the turbine is omni-directional, in the sense that it operates effectively with the wind blowing in any direction. This is particularly advantageous on sites where the wind direction is highly variable. Vertical axis wind turbines also cope well with both wind sheer and turbulence.

Until recently vertical axis wind turbine blades were mounted vertically in at least one plane. In the last few years however, spiral-shaped blades have become known and these provide a constant angle of attack and maintain a constant radius and cross-sectional area. However, these blades have presented problems in manufacture and balance, with the need for central struts.

According to a first aspect of the present invention there is provided a wind turbine comprising:

an axis intended for vertical mounting;

a first plurality of blades arranged around the axis, each blade comprising a substantially symmetric aerofoil and being of substantially straight section lengthwise; and

a second plurality of mounting arms coupled to the axis and extending substantially perpendicular to the axis, each mounting arm comprising a fairing of aerofoil shape,

each blade being mounted to the axis at both ends on respective mounting arms such that the mounting arms act as tip vanes, and

the mounting arms of each blade being angularly spaced around the axis such that each blade is arranged rotated at an angle to the vertical in use and one arm leads the other when the turbine is rotating.

The attachment of the mounting arms to the ends of the respective blades causes the mounting arms to act as tip vanes, which may reduce or prevent induced drag on the blades, thereby improving the performance of the wind turbine. The angular separation of the mounting arms of a blade may allow the attachment of the flow on the upwind side and the stall on the downwind side to happen progressively along the blade as it rotates rather than as a step change. This may have the mechanical benefit of smoothing out any otherwise pulsating torque output reducing the cyclic stresses on a drive shaft and attached couplings to an electrical generator.

In an embodiment, the mounting arms extend over the respective ends of the blades and are connected to the respective ends of the blades. The operation of the mounting arms as tip vanes may thus be optimised.

In an embodiment, each blade is arranged rotated at an angle of between 10 and 80 degrees. In an embodiment, each blade is arranged rotated at an angle of between 30 and 60 degrees.

In an embodiment, the mounting arms are of substantially the same length.

In an embodiment, each blade is raked about its aerodynamic centre. The chord of each blade thus lies parallel to the tangent of the circle of rotation along its whole length. It thus achieves a constant angle of attack, like spiral blades do. Hence, the benefit of a constant angle of attack of the blades offered by spiral blades may be provided by the present wind turbine for a much simpler blade construction and only a small sacrifice in cross-sectional area may be required.

In an embodiment, each blade is arranged substantially symmetrically about its aerodynamic centre. The radius of the swept blades thus varies along its length, being maximum at the extremities and minimum at the centre. The angle of attack of the blades thus varies along the span of the blades.

The chord length of each mounting arm may be substantially constant along its length or may decrease from one end of to the other.

In an embodiment, each blade is adapted to rotate chord-wise about an axis along its length. The angle of attack of each blade may therefore be feathered. In an embodiment, the mounting arms are arranged in a close-fitting relationship with the respective ends of the blades, the blades being free to move relative to the mounting arms such that the blades may be feathered.

In an embodiment, each mounting arm comprises a cambered aerofoil arranged at an angle of attack of approximately zero degrees. In an embodiment, each mounting arm comprises a substantially symmetric aerofoil arranged at an angle of attack of between zero and plus or minus five degrees, generally towards the centre of the turbine.

In an embodiment, each mounting arm has a chord width of between one third and one chord width of the respective blade.

In an embodiment, a ratio of the height of the wind turbine to its diameter is between 0.5 and 0.7, more preferably between 0.59 and 0.65, and more preferably substantially equal to 0.62.

The wind turbine may be mounted inside an augmenter cage. The cage may be adapted to augment the flow of air onto the turbine in use. The cage may be arranged above a supporting surface. The cage may comprise a plurality of stator blades arranged lengthwise substantially parallel to the axis, with the stator blades being adapted and arranged to augment the flow of air onto the turbine in use. The cage may also comprise annular rings for supporting the stator blades at each end. The annular rings themselves may be adapted and arranged to augment the flow of air onto the turbine in use.

The cage may be arranged directly on top of the supporting surface.

The cage may be spaced apart from the supporting surface by a support structure that allows substantially free flow of air between the cage and the supporting surface.

The support structure may comprise a plurality of pillars.

The separation between the cage and the supporting surface may be at least half the height of the cage.

The separation between the cage and the supporting surface may be at least 10 metres.

The supporting surface may form an uppermost part of a building.

The cage may form an integral part of the uppermost part of the building.

The cage may be substantially equal in lateral extent to the building.

The building may be a substantially circular tower.

The building may comprise a prefabricated concrete ringbeam, and a plurality of concrete pillars for supporting the ringbeam.

At least part of the supporting surface may be shaped so as to augment the flow of air onto the turbine in use.

A second aspect of the invention provides a wind turbine system comprising a plurality of wind turbines as described above, the wind turbines being arranged along a common axis and adjacent wind turbines being arranged in a spaced relationship, the mounting arms of a first wind turbine being angularly spaced around the axis with respect to the mounting arms of a second wind turbine, such that the blades of the first and second wind turbines are arranged out of phase with one another.

A third aspect of the invention provides a wind turbine comprising:

an axis intended for vertical mounting;

a first plurality of blades arranged around the axis, each blade comprising a substantially symmetric aerofoil and being of substantially straight section lengthwise;

a second plurality of mounting arms coupled to the axis and extending substantially perpendicular to the axis, each blade being mounted to the axis at both ends on respective mounting arms, and the mounting arms of each blade being angularly spaced around the axis such that each blade is arranged rotated at an angle to the vertical in use and one arm leads the other when the turbine is rotating; and

an augmenter cage within which the axis, blades and mounting arms are mounted, the augmenter cage being arranged to divert a first part of an airflow incident on the wind turbine such that the air pressure in an area above the augmenter cage is lower than the air pressure within the cage, such that a second part of the airflow which enters the augmenter cage is caused to exit the augmenter cage in an upwardly direction, towards the area of lower air pressure.

An airflow incident on the wind turbine is accelerated as it is funneled through the augmenter cage. This pressure difference between the inside of the augmenter cage and the low pressure area above it causes ‘spent’ air to be exhausted upwards, rather than through the stalled blades at the rear (in the direction of the airflow) of the turbine, increasing the pressure drop across the turbine. This may aid the flow of air into the augmenter cage, thereby improving the performance of the wind turbine.

The angular separation of the mounting arms of a blade may allow the attachment of the flow on the upwind side and the stall on the downwind side to happen progressively along the blade as it rotates rather than as a step change. This may have the mechanical benefit of smoothing out any otherwise pulsating torque output reducing the cyclic stresses on a drive shaft and attached couplings to an electrical generator.

In an embodiment, the augmenter cage comprises a plurality of stator blades arranged lengthwise substantially parallel to the axis and upper and lower annular rings for supporting the stator blades at each end, the stator blades being arranged to accelerate the second part of the airflow and the upper annular ring being arranged to divert the first part of the airflow. The smooth running provided by the angled blades may allow negligible vibration and minimal aerodynamic noise even when passing stationary objects such as the stator blades since the swept blades of the turbine peel past the stators rather than pulse past them.

In an embodiment, the lower annular ring is also arranged to divert the first part of the airflow incident on the wind turbine such that the air pressure in an area below the augmenter cage is also lower than the air pressure within the cage, such that the second part of the airflow which enters the augmenter cage is caused to exit the augmenter cage in both upwardly and downwardly directions, towards the areas of lower air pressure.

In an embodiment, a ratio of the height of the augmenter cage to its diameter is between 0.4 and 0.6, more preferably between 0.47 and 0.53, and more preferably substantially equal to 0.5.

In an embodiment, each stator blade is arranged at an angle of approximately −30 degree to the radius of the upper and lower annual rings are arranged at an angle of approximately +30 degrees and approximately −30 degrees to the horizontal respectively.

In an embodiment, the wind turbine further comprises a support structure on which the augmenter cage is provided, the support structure having a height of at least one half of the height of the augmenter cage. In an embodiment, the support structure has a height of at least 10 metres.

In an embodiment, the augmenter cage is adapted to be provided on a supporting surface comprising an uppermost part of a building. In an embodiment, the augmenter cage forms an integral part of the uppermost part of the building. In an embodiment, the augmenter cage is substantially equal in lateral extent to the building. In an embodiment, the building is a substantially circular tower.

In an embodiment, at least part of the supporting surface is shaped so as to augment the flow of air onto the turbine in use. In an embodiment, an outer surface of the lower annular ring and the supporting surface form a substantially continuous surface where they meet.

A fourth aspect of the invention provides a wind turbine assembly comprising a plurality of wind turbines according to the third aspect of the invention as described above, the wind turbines being arranged along a common axis and the mounting arms of a first wind turbine being angularly spaced around the axis with respect to the mounting arms of a second wind turbine, such that the blades of the first and second wind turbines are arranged out of phase with one another.

A wind turbine assembly is thereby provided having a generating capacity which may be controlled by setting the number of wind turbines within the assembly. Arranging the blades out of phase may provide continual smooth torque generation.

A fifth aspect of the invention provides a building comprising a wind turbine according to the third aspect of the invention as described above, and wherein at least part of a surface of the building is shaped so as to further augment the flow of air onto the turbine in use.

Embodiments of the invention will now be described, by way of example only, with reference to the accompanying drawings, in which:

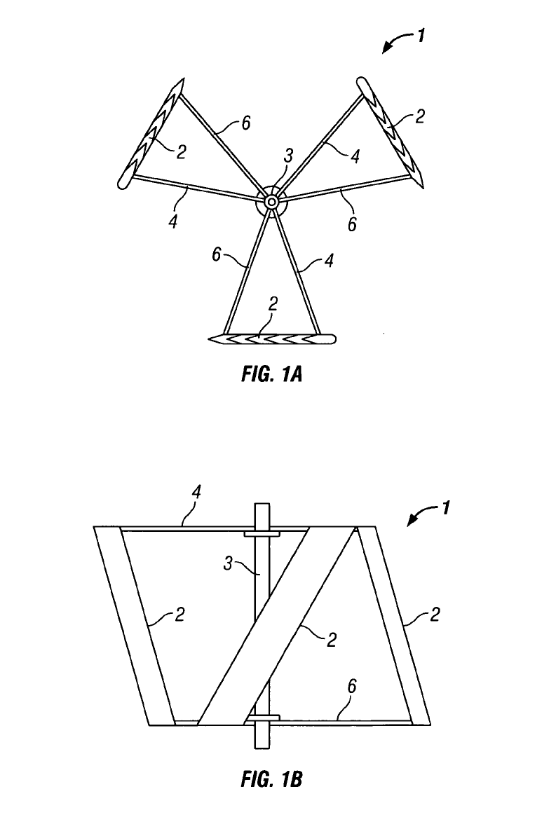

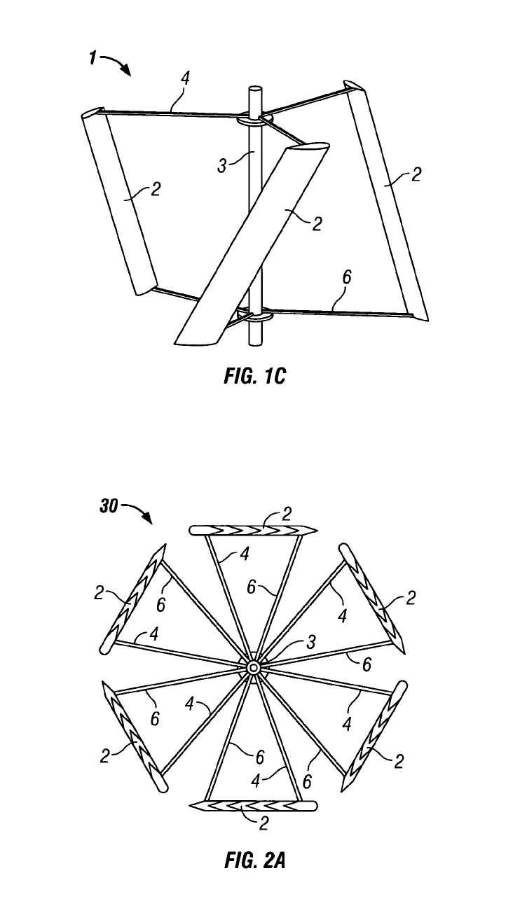

FIG. 1A is a plan view illustration of a wind turbine according to an embodiment of a first aspect of the present invention;

FIG. 1B shows an elevation view of the wind turbine of FIG. 1A;

FIG. 1C shows an orthographic view of the wind turbine of FIG. 1A;

FIG. 2A is a plan view illustration of a wind turbine according to an embodiment of a second aspect of the present invention;

FIG. 2B shows an elevation view of the wind turbine of FIG. 2A;

FIG. 2C shows an orthographic view of the wind turbine FIG. 2A;

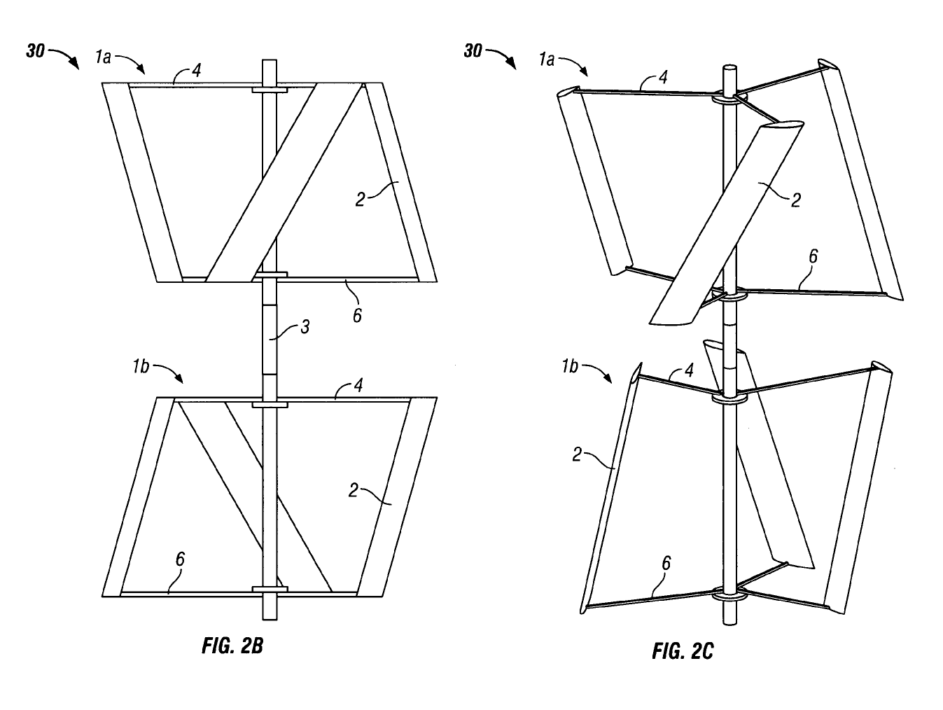

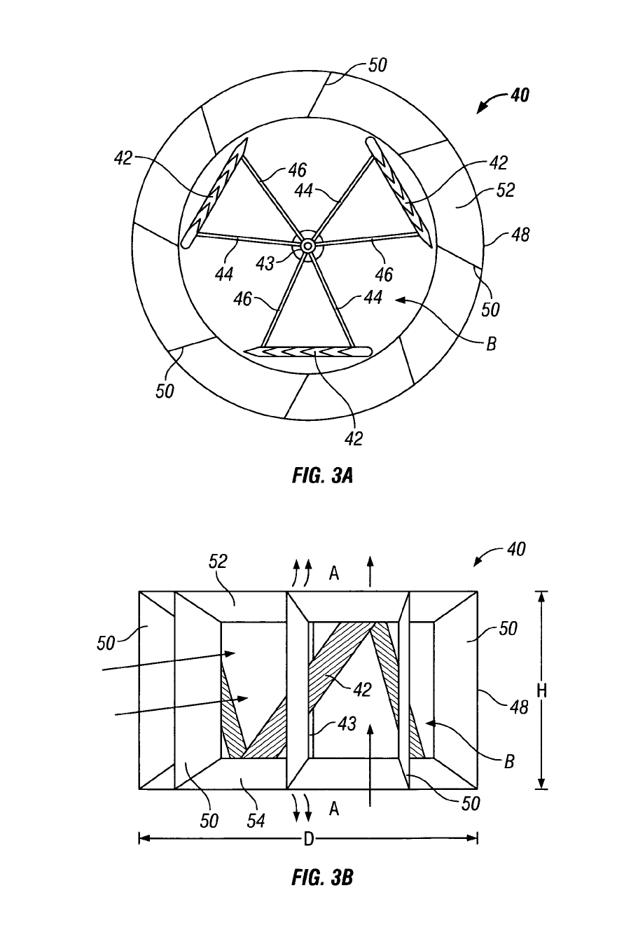

FIG. 3A is a plan view illustration of a wind turbine according to a first embodiment of a third aspect of the present invention;

FIG. 3B shows an elevation view of the wind turbine of FIG. 3A;

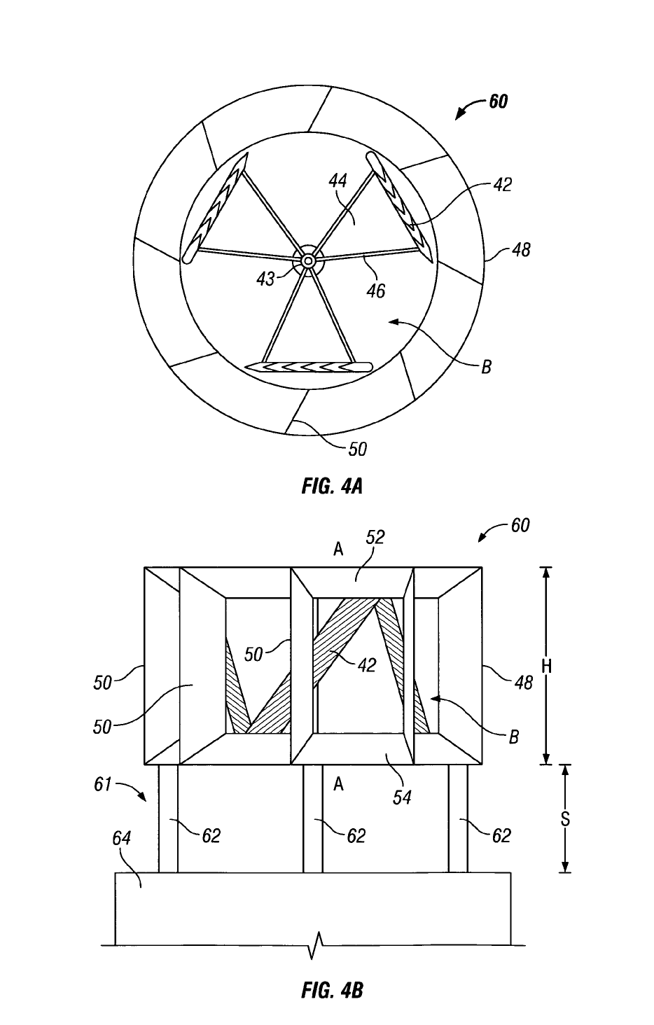

FIG. 4A is a plan view illustration of a wind turbine according to a second embodiment of the third aspect of the present invention;

FIG. 4B shows an elevation view of the wind turbine of FIG. 4A;

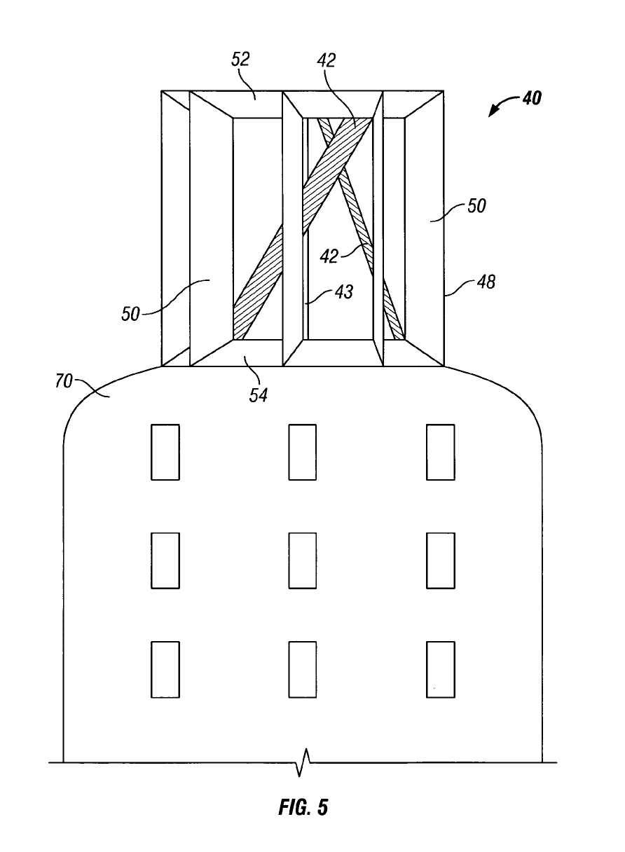

FIG. 5 is an elevation view illustration of a third embodiment of the third aspect of the present invention;

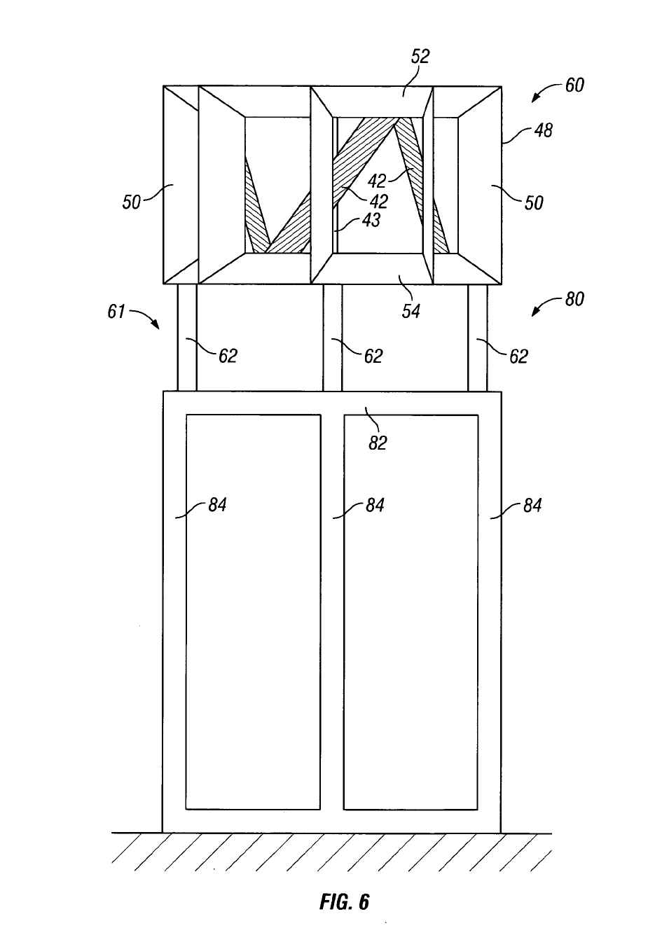

FIG. 6 is an elevation view illustration of a fourth embodiment of the third aspect of the present invention; and

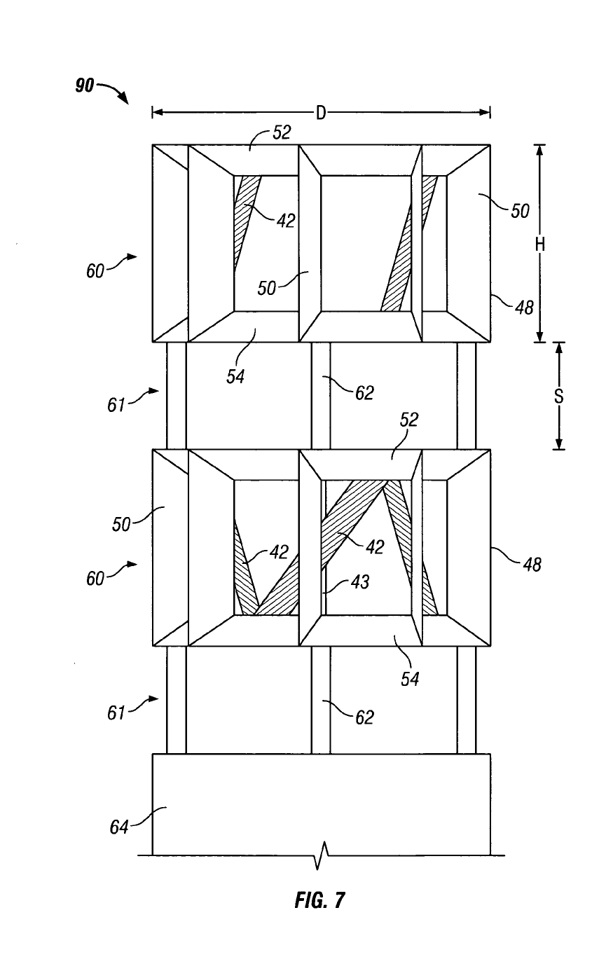

FIG. 7 is an elevation view illustration of an embodiment of a fourth aspect of the present invention.

FIGS. 1A to 1C illustrate a wind turbine 1 according to an embodiment of a first aspect of the present invention, with FIG. 1A showing a plan view of the wind turbine 1, FIG. 1B showing an elevation view of the wind turbine 1, and FIG. 1C showing an orthographic view of the vertical axis wind turbine 1.

The wind turbine 1 is a vertical axis wind turbine comprising an axis 3 intended for vertical mounting and a plurality of blades 2 arranged around the axis 3. In this example, three blades 2 are provided arranged in an equally space relationship, that is at an angular separation around the axis 3 of 120 degrees. Each blade 2 comprises a symmetrical aerofoil and has a substantially straight section lengthwise. If one considers a plane in which the axis 3 lies, with the plane passing through one of the blades 2 (for example the centre of the blade 2), the blade 2 is arranged to make a non-zero angle to that plane; this is the case for each of the blades 2. If one considers a further plane in which the axis 3 lies that is perpendicular to the above-mentioned plane passing through the blade, the blade 2 lies substantially parallel to that further plane (as depicted in FIG. 1A).

In this embodiment, the blades 2 are mounted both top and bottom on substantially horizontal mounting arms 4, 6 coupled to the axis 3. The mounting arms 4, 6 have a chord width of approximately one third of the chord width of the blades 2. The mounting arms 4, 6 are shown schematically only in the drawings and are not drawn to scale relative to the blades 2.

The mounting arms 4, 6 of each blade 2 are angularly spaced around the axis 3 from one another, such that the top mounting arm 4 leads the bottom arm 6 in the circle of rotation. The blades 2 are thereby arranged rotated at an angle to the vertical in use. Each blade 2 makes an angle greater than 0 but less than 90 degrees to the vertical, preferably between 10 and 80 degrees to the vertical and more preferably between 30 and 60 degrees to the vertical.

The mounting arms 4, 6 each comprise a fairing of aerofoil shape and are connected to the respective blades 2 so as to act as tip vanes, thereby reducing “induced drag” on the blades 2. This is the reason for mounting the blades top and bottom, rather than some distance in from the end, in accord with the bending moment of the blade. This is facilitated by a small height/diameter ratio of turbine, which preferably is of the order of 0.62. The mounting arms 4, 6 in this example extend over the ends of the respective blades 2 and are closely fitted to the ends of the respective blades 2. If the blades 2 are mounted such that they may be feathered then the fitting between the mounting arms 4, 6 and the blades 2 must not be a tight fit but must allow for relative movement of the blades 2 with respect to the mounting arms 4, 6.

The mounting arms 4, 6 have an aerodynamic profile, which in this example takes the form of a cambered aerofoil, with the arms 4, 6 mounted at a 0 degree angle of attack. Alternatively, the mounting arms 4, 6 may comprise a symmetric aerofoil arranged at an angle of attack of between zero and plus or minus five degrees, generally towards the centre of the turbine.

The blades 2 provide at least one of the following aerodynamic or mechanical advantages. The chord of the blade is increased relative to the wind, and this increases the Reynolds number, which in turn improves the lift and hence the performance. Both the attachment of the flow on the upwind side and the stall on the downwind side happen progressively along the blade as it rotates rather than as a step change. This has the mechanical benefit of smoothing out any otherwise pulsating torque output reducing the cyclic stresses on the drive shaft and attached couplings to the electrical generator. Smooth running implies negligible vibration and minimal aerodynamic noise even when passing stationary objects such as augmenting stator blades (see below) since the swept blades of the rotor peel past the stators rather than pulse past them.

The angled (or “swept”) blades 2 have, unlike spiral blades, a straight section such that the chord of each blade 2 lies parallel to the tangent of the circle of rotation along its whole length when the blade 2 is raked about its aerodynamic centre. It thus achieves a constant angle of attack, like the spiral blades do. However, while spiral blades maintain a constant radius, the radius of the swept blades according to an embodiment of the present invention varies along its length, being maximum at the extremities and minimum at the centre. Hence, for only a small sacrifice in cross-sectional area, the benefits of spiral blades are achieved using the angled or swept blade embodying the present invention, which has a much simpler blade construction.

The blades 2 may alternatively be unraked (symmetrically mounted) which will result in the angle of attack varying along the span of the blade.

For maximum aerodynamic benefit the ratio of the height of the turbine to its diameter is between 0.5 and 0.7, and most preferably between 0.59 and 0.65. In this example it is substantially equal to 0.62.

FIGS. 2A to 2C illustrate a wind turbine assembly 30 according to an embodiment of a second aspect of the present invention. The wind turbine assembly 30 comprises two wind turbines 1 as shown in FIGS. 1A to 10. The turbines 1a, b are arranged along a common axis 3 in a spaced relationship. The mounting arms 4, 6 of the upper wind turbine 1a are angularly spaced around the axis with respect to the mounting arms 4, 6 of the lower wind turbine 1b, such that the blades of the first and second wind turbines 1a, b are arranged out of phase with one another.

FIGS. 3A and 3B illustrate a wind turbine 40 according to a first embodiment of a third aspect of the present invention. The wind turbine 40 is a vertical axis wind turbine comprising an axis 43 intended for vertical mounting and a plurality of blades 42 arranged around the axis 43. In this example, three blades 42 are provided arranged in an equally spaced relationship, that is at an angular separation around the axis 43 of approximately 120 degrees. Each blade 42 comprises a symmetrical aerofoil and has a substantially straight section lengthwise. If one considers a plane in which the axis 43 lies, with the plane passing through one of the blades 42 (for example the centre of the blade 42), the blade 42 is arranged to make a non-zero angle to that plane; this is the case for each of the blades 42. If one considers a further plane in which the axis 33 lies that is perpendicular to the above-mentioned plane passing through the blade, the blade 32 lies substantially parallel to that further plane (as depicted in FIG. 3A).

In this embodiment, the blades 42 are mounted both top and bottom on substantially horizontal mounting arms 44, 46 coupled to the axis 43. The mounting arms 44, 46 of each blade 32 are angularly spaced around the axis 33 from one another, such that the top mounting arm 34 leads the bottom arm 36 in the circle of rotation. The blades 32 are thereby arranged rotated at an angle to the vertical in use. Each blade 32 makes an angle greater than 0 but less than 90 degrees to the vertical, preferably between 10 and 80 degrees to the vertical and more preferably between 30 and 60 degrees to the vertical.

The blades 42 provide at least one of the following aerodynamic or mechanical advantages. The chord of the blade is increased relative to the wind, and this increases the Reynolds number, which in turn improves the lift and hence the performance. Both the attachment of the flow on the upwind side and the stall on the downwind side happen progressively along the blade as it rotates rather than as a step change. This has the mechanical benefit of smoothing out any otherwise pulsating torque output reducing the cyclic stresses on the drive shaft and attached couplings to the electrical generator. Smooth running implies negligible vibration and minimal aerodynamic noise even when passing stationary objects such as augmenting stator blades (see below) since the swept blades of the rotor peel past the stators rather than pulse past them.

The angled (or “swept”) blades 42 have, unlike spiral blades, a straight section such that the chord of each blade 2 lies parallel to the tangent of the circle of rotation along its whole length when the blade 2 is raked about its aerodynamic centre. It thus achieves a constant angle of attack, like the spiral blades do. However, while spiral blades maintain a constant radius, the radius of the swept blades according to an embodiment of the present invention varies along its length, being maximum at the extremities and minimum at the centre. Hence, for only a small sacrifice in cross-sectional area, the benefits of spiral blades are achieved using the angled or swept blade embodying the present invention, which has a much simpler blade construction.

The blades 42 may alternatively be unraked (symmetrically mounted) which will result in the angle of attack varying along the span of the blade.

The wind turbine assembly 40 further comprises an augmenter cage 48 in which the blades 42, axis 43 and mounting arms 44, 46 are mounted. The augmenter cage 48 is arranged to divert a first part of an airflow incident on the wind turbine 40 such that the air pressure in areas A above and below the augmenter cage 48 is lower than the air pressure within the cage B, such that a second part of the airflow which enters the augmenter cage 48 is caused to exit the augmenter cage in an upwardly and downwardly direction (as indicated by the arrows), towards the areas of lower air pressure.

In this embodiment, the augmenter cage 48 comprises a plurality of stator blades 50 arranged lengthwise substantially parallel to the axis 43, an upper annular ring 52 and a lower annular ring 54 which support the stator blades at each end. The upper and lower annular rings comprise flat, curved sheets arranged at an angle of +30 degrees and −30 degrees to the horizontal respectively. A first part of an airflow incident on the wind turbine 40 encounters the annular rings 52, 54 and is diverted upwards and downwards respectively, and caused to trip over the uppermost and lower most edges of the upper and lower annular rings 52, 54. This causes vortices to form behind the upwind sections of the annular rings 52, 54, and the free stream of the airflow is diverted above and below the initial vortices. Low pressure in this fast moving fluid and that combined with the low pressure of the vortices creates low pressure regions A, above and below the turbine 40.

The stator blades 50 and the upper and lower annular rings 52, 54 act as a flow converger upwind of the blades 42 and a flow diverger downwind of the blades 42, and are arranged to concentrate and accelerate the second part of the airflow into the augmenter cage 48. An airflow incident on the wind turbine 40 is accelerated as it is funneled through the augmenter cage 48. This pressure difference between the inside of the augmenter cage and the low pressure regions A above and below it causes ‘spent’ air to be exhausted upwards and downwards (due to the Bernoulli effect), rather than through the stalled blades at the rear (in the direction of the airflow) of the turbine 40, increasing the pressure drop across the turbine. This may aid the flow of air into the augmenter cage 48, thereby improving the performance of the wind turbine 40.

For maximum aerodynamic benefit the ratio of the height (H) of the augmenter cage to its diameter (D) is between 0.4 and 0.6, and most preferably between 0.47 and 0.53. In this example the ratio is substantially equal to 0.5.

FIGS. 4A and 4B illustrate a wind turbine 60 according to a second embodiment of the third aspect of the present invention. The wind turbine 60 is substantially the same as the wind turbine 40 of the previous embodiment, with the following modifications.

In this embodiment, the wind turbine further comprises a support structure 61 on which the augmenter cage 48 is supported. The support structure consists of a number of pillars 62, preferably four or more. The support structure 61 is intended to be located on a support surface 64. The separation S between the support surface 64 and the augmenter cage 48, i.e. the height of the support structure 61, is at least half the height H of the augmenter cage 48.

Providing a support structure 61 to the wind turbine 60 has the aerodynamic benefit of raising the turbine into the accelerated free stream above the support surface 64, which may for example comprise a building roof, the support structure 61 raising the augmenter cage 48 and blades 42 etc above any roof turbulence. This flow is further accelerated as it is funneled between the roof vortices and those tripped from the outer edge of the lower annular ring 54. The pressure in this flow below the turbine augmenter cage 48 is now very much lower than the ‘spent’ air inside the turbine 60. This pressure difference exhausts the ‘spent’ air downward, rather than through the stalled blades at the rear of the turbine 60, increasing the pressure drop across the turbine 60, aiding the flow through the convergent entry ducts, thereby improving the performance. In addition the pillars 62 make for a stable structure, spreading the load on the supporting surface 64, for example a roof, and enabling it to withstand extreme wind conditions likely to be encountered when mounted atop high rise buildings.

FIG. 5 shows a third embodiment of the third aspect of the present invention, in which a wind turbine 40, as shown in FIGS. 3A and 3B is mounted on top of a building inside a ring of stator blades 8, mounted on and topped by two convergent annular rings 10. The wind turbine 60 is mounted on top of a building 70 in such a way that the augmenter cage 48 effectively forms an integral part of the building 70. The augmenter cage 48 could be equal in diameter to the building itself, as in the case of a circular tower, or mounted on top of a domed roof of the building 70 as is shown in the FIG. 5 example. Such building design would considerably augment the output of the turbine as it would serve to increase the wind speed incident on the turbine 40. The lower convergent annular ring 54 and the top of the building 70 form a substantially continuous surface where they meet, so that the surface of one continues smoothly into the other or provided with aerodynamic slots, thus enhancing integration between the two.

The arrangement for supporting a vertical axis wind turbine on a building as described in relation to FIG. 5 is used in a fourth embodiment of the third aspect of the present invention to apply to freestanding installations, as is illustrated in FIG. 6. The wind turbine 80 of this embodiment is substantially the same as the wind turbine 60 of FIGS. 4A and 4B, with the following modifications. The same reference numbers are retained for corresponding features. In this embodiment, the wind turbine further comprises a concrete ringbeam 82 and multiple concrete pillars 84. The augmenter cage 48 is mounted on top of wth ringbeam 82 via the pillars 62 of the support structure 61. The ringbeam 82 is supported many metres above the ground, preferably a minimum of 10 metres, by the concrete pillars 84. Alternatively, this can be achieved by extending the pillars 62 of the support structure 61 by the same amount as the concrete pillars 84 of FIG. 4, thereby raising the augmenter cage 48 above the worst of the surface friction. Together, the prefabricated concrete ringbeam 82 and concrete pillars 84 form a further support structure.

The multiple leg structure not only makes for a stable structure, but it enables the wind turbine to be enlarged to a scale well beyond that achievable by any other vertical axis wind turbine, extending the range of green power generation and bringing to it the benefits of omni-directional augmentation, smooth balanced rotation, lack of noise and passive control. The further support structure may also be clad to blend with its environment and at the same time provide a useful space.

A fourth aspect of the invention provides a wind turbine assembly 90 as shown in FIG. 7. The assembly 90 comprises a plurality, in this example two, of wind turbines 60 as shown in FIGS. 4A and 4B.

The wind turbines 60 are stacked one (or more) above the other, each augmenter cage 48 being spaced apart by the height of the support structure 61; this is illustrated in FIG. 7. The separation S between augmenter cages 48 is preferably at least half the height H of the augmenter cages 48.

The reason for providing a separation S between augmenter cages 48 is the same as that described above in relation to FIG. 4B. In the example shown in FIG. 7, the effect is achieved through the gaps between the augmenter cages 48, as well as between the roof 64 (or ground or other support structure e.g. 19) and the augmenter cage 48 of the lowermost turbine 60, and also over the uppermost turbine 60. The end result is that the ‘spent’ flow is exhausted both ways, downward and upward, further improving the pressure drop across the wind turbine assembly 90 and hence the performance. For maximum aerodynamic benefit the height H to diameter D ratio (H/D) of the augmenter cage 48 should preferably be of the order of 0.5.

The wind turbines 60 can each specifically be designed to be made of a plurality of identical components both to facilitate, and to reduce the cost of: a) manufacture; b) transportation to site/roof top; and c) erection.

It will be appreciated by the person of skill in the art that various modifications may be made to the above described embodiments without departing from the scope of the present invention. It will particularly be appreciated that, although an aspect may be described as building upon and including the features of another aspect, it does not follow that all the features of the related aspect are essential; for example none of the second to fourth aspects requires the angled turbine blades of the first aspect, since any type of vertical axis wind turbine would suffice.

1. A wind turbine comprising:
an axis intended for vertical mounting;
a first plurality of blades arranged around the axis, each blade comprising a substantially symmetric aerofoil and being of substantially straight section lengthwise; and
a second plurality of mounting arms coupled to the axis and extending substantially perpendicular to the axis, each mounting arm comprising a fairing of aerofoil shape, such that the mounting arms act as tip vanes,
each blade being mounted to the axis at both ends on respective mounting arms, and
the mounting arms of each blade being angularly spaced around the axis such that each blade is arranged rotated at an angle to the vertical in use and one arm leads the other when the turbine is rotating.

2. A wind turbine as claimed in claim 1, wherein each blade is arranged rotated at an angle of between 10 and 80 degrees.

3. A wind turbine as claimed in claim 2, wherein each blade is arranged rotated at an angle of between 30 and 60 degrees.

4. A wind turbine as claimed in claim 1, wherein the arms are of substantially the same length.

5. A wind turbine as claimed in claim 1, wherein each blade is adapted to rotate chord-wise about an axis along its length.

6. A wind turbine as claimed in claim 1, wherein each mounting arm comprises a cambered aerofoil arranged at an angle of attack of approximately zero degrees.

7. A wind turbine as claimed in claim 1, wherein each mounting arm comprises a substantially symmetric aerofoil and is arranged with its leading edge arranged at an angle of attack of between zero and plus or minus five degrees, generally towards the centre of the turbine.

8. A wind turbine as claimed in claim 1, wherein each mounting arm has a chord width of between one third and one chord width of the respective blade.

9. A wind turbine as claimed in claim 1, wherein a ratio of the height of the wind turbine to its diameter is between 0.5 and 0.7, more preferably between 0.59 and 0.65, and more preferably substantially equal to 0.62.

10. A wind turbine assembly comprising a plurality of wind turbines as claimed in claim 1, the wind turbines being arranged along a common axis and adjacent wind turbines being arranged in a spaced relationship, the mounting arms of a first wind turbine being angularly spaced around the axis with respect to the mounting arms of a second wind turbine, such that the blades of the first and second wind turbines are arranged out of phase with one another.

11. A wind turbine comprising:
an axis intended for vertical mounting;
a first plurality of blades arranged around the axis, each blade comprising a substantially symmetric aerofoil and being of substantially straight section lengthwise;
a second plurality of mounting arms coupled to the axis and extending substantially perpendicular to the axis, each blade being mounted to the axis at both ends on respective mounting arms, and the mounting arms of each blade being angularly spaced around the axis such that each blade is arranged rotated at an angle to the vertical in use and one arm leads the other when the turbine is rotating; and
an augmenter cage within which the axis, blades and mounting arms are mounted, the augmenter cage being arranged to divert a first part of an airflow incident on the wind turbine such that the air pressure in an area above the augmenter cage is lower than the air pressure within the cage, such that a second part of the airflow which enters the augmenter cage is caused to exit the augmenter cage in an upwardly direction, towards the area of lower air pressure.

12. A wind turbine as claimed in claim 11, wherein the augmenter cage comprises a plurality of stator blades arranged lengthwise substantially parallel to the axis and upper and lower annular rings for supporting the stator blades at each end, the stator blades being arranged to accelerate the second part of the airflow and the upper annular ring being arranged to divert the first part of the airflow.

13. A wind turbine as claimed in claim 12, wherein the lower annual ring is also arranged to divert the first part of the airflow incident on the wind turbine such that the air pressure in an area below the augmenter cage is also lower than the air pressure within the cage, such that the second part of the airflow which enters the augmenter cage is caused to exit the augmenter cage in both upwardly and downwardly directions, towards the areas of lower air pressure.

14. A wind turbine as claimed in claim 11, wherein a ratio of the height of the augmenter cage to its diameter is between 0.4 and 0.6, more preferably between 0.47 and 0.53, and more preferably substantially equal to 0.5.

15. A wind turbine as claimed in claim 11, wherein each stator blade is arranged at an angle of approximately −30 degree to the radius of the upper and lower annual rings are arranged at an angle of approximately +30 degrees and approximately −30 degrees to the horizontal respectively.

16. A wind turbine as claimed in claim 11, wherein the wind turbine further comprises a support structure on which the augmenter cage is provided, the support structure having a height of at least one half of the height of the augmenter cage.

17. A wind turbine as claimed in claim 16, wherein the support structure has a height of at least 10 metres.

18. A wind turbine as claimed in claim 12, wherein the augmenter cage is adapted to be provided on a supporting surface comprising an uppermost part of a building.

19. A wind turbine as claimed in claim 18, wherein the augmenter cage forms an integral part of the uppermost part of the building.

20. A wind turbine as claimed in claim 18, wherein the augmenter cage is substantially equal in lateral extent to the building.

21. A wind turbine as claimed in claim 18, wherein the building is a substantially circular tower.

22. A wind turbine as claimed in claim 18, wherein at least part of the supporting surface is shaped so as to augment the flow of air onto the turbine in use.

23. A wind turbine as claimed in claim 22, wherein an outer surface of the lower annular ring and the supporting surface form a substantially continuous surface where they meet.

24. A wind turbine assembly comprising a plurality of wind turbines as claimed in claim 16, the wind turbines being arranged along a common axis and the mounting arms of a first wind turbine being angularly spaced around the axis with respect to the mounting arms of a second wind turbine, such that the blades of the first and second wind turbines are arranged out of phase with one another.

25. A building comprising a wind turbine as claimed in claim 11, and wherein at least part of a surface of the building is shaped so as to further augment the flow of air onto the turbine in use.
